(19) United States
(12) Patent Application Publication
(10) Pub. No.: US 2021/0191193 A1
(43) Pub. Date: Jun. 24, 2021

(54) LIQUID CRYSTAL DISPLAY DEVICE

(71) Applicant: WUHAN CHINA STAR OPTOELECTRONICS TECHNOLOGY CO., LTD., Wuhan (CN)

(72) Inventors: Fancheng LIU, Wuhan (CN); Guowei ZHA, Wuhan (CN)

(21) Appl. No.: 16/339,364

(22) PCT Filed: Nov. 1, 2018
(86) PCT No.: PCT/CN2018/113264

§ 371 Date: Apr. 4, 2019

(30) Foreign Application Priority Data
Sep. 27, 2018 (CN) 201811130569.4

(51) Int. Cl. G02F 1/1335; G02F 1/1333; G02F 1/13357

(52) U.S. Cl. CPC G02F 1/133528; G02F 1/133602; G02F 1/133514; G02F 1/133308

(57) ABSTRACT

A liquid crystal display device is provided. The liquid crystal display device mainly includes a liquid crystal panel, a first polarizer, a second polarizer, and a backlight module, wherein the first polarizer is disposed under the liquid crystal panel, the second polarizer is disposed above the liquid crystal panel, and the backlight module is disposed under the first polarizer. Furthermore, the liquid crystal display device has a sensing area and a sensor, the backlight module has an opening corresponding to the sensing area, and the sensor is disposed inside or below the opening. Thus, when the liquid crystal display device is in a power-off state, a user cannot see the sensor from outside, and when the liquid crystal display device is in a power-on state, the user can see the sensor.

### FIELD OF INVENTION

The present disclosure relates to a liquid crystal display device, and more particularly to a liquid crystal display device in which a sensor is disposed in a visible area of a liquid crystal panel.

### BACKGROUND OF INVENTION

Liquid crystal display devices generally refer to various devices which use liquid crystal panels, such as displays and various mobile devices, wherein mobile phones are the most representative mobile devices.

With continuous improvement of manufacturing process of mobile phones, mobile phone screens of the mobile phone tends toward larger sizes and larger screen-to-body ratio. The screen-to-body ratio is used to indicate a ratio of the area of the mobile phone screen and the front panel of the mobile phone, and the current screen-to-body ratio of the mobile phone has gradually increased from 80% to more than 90%.

However, in order to further improve the screen-to-body ratio of the mobile phone, in the prior art, the front sensor portion of the mobile phone is included in a visible area of the mobile phone screen, that is, the screen-to-body ratio is increased by digging a hole in the mobile phone screen, thereby improve the overall aesthetic design of the mobile phone.

Referring to FIG. 1, which is a schematic partial cross-sectional view of a conventional liquid crystal display device. A conventional liquid crystal display device 100, for example a mobile phone, is mainly includes a liquid crystal panel 110. The liquid crystal panel 110 includes a first transparent substrate 111, a second transparent substrate 112, and a liquid crystal layer 113. A plurality of thin film transistors 111a are disposed on the first transparent substrate 111. A plurality of color resist unit 112a are disposed on the second transparent substrate 112. The liquid crystal layer 113 is filled in an enclosed structure formed by the first transparent substrate 111 and the second transparent substrate 112.

Furthermore, the liquid crystal display device 100 further includes a first polarizer 120 disposed under the liquid crystal panel 110, a second polarizer 130 disposed above the liquid crystal panel 110, a backlight module 140 disposed under the first polarizer 120, an optical adhesive layer (OCA: optical clear adhesive) 150 disposed above the second polarizer 130, and a transparent cover 160 disposed above the optical adhesive layer 150.

Furthermore, the liquid crystal display device 100 further includes a sensor 170. In order to include the sensor 170 into the visible area of the liquid crystal panel 110, the liquid crystal display device 100 is provided with a sensing area A, and in the sensing area A, the first polarizer 120, the second polarizer 130, and the backlight module 140 are provided with openings, respectively, and the sensor 170 is disposed under the openings. Therefore, an external light (as indicated by an arrow in FIG. 1) can pass through the sensing area A of the liquid crystal display device 100, so that the sensor 170 can perform a sensing operation. The sensor 170 such as a camera, a photosensitive sensor, an infrared sensor, and a fingerprint sensor. When the sensor 170 is a camera, a photo or film work can be performed through the sensing area A.

However, because such method of digging hole is adopted, a user can see the sensor 170 disposed under the liquid crystal panel 110 from outside no matter the liquid crystal display device 100 is in power-on or power-off state, so that the screen-to-body ratio of the liquid crystal display device 100 can be increased, but that also influences the overall aesthetic feeling of the liquid crystal display device 100 to a certain degree.

Therefore, it is necessary to provide an improved liquid crystal display device to solve the above technical problems.

### SUMMARY OF INVENTION

A primary object of the present disclosure is to provide a liquid crystal display device including a sensor disposed in a visible area of a liquid crystal display panel. When the liquid crystal display device is in a power-off state, a user cannot see the sensor disposed under a liquid crystal panel from outside, and when the liquid crystal display device is in a power-on state, the user can see the sensor disposed under the liquid crystal panel from outside.

To achieve the above object, the present disclosure provides a liquid crystal display device, which comprises: a liquid crystal panel comprising a first transparent substrate, a second transparent substrate and a liquid crystal layer, wherein the liquid crystal layer is filled in an enclosed structure formed by the first transparent substrate and the second transparent substrate, and the liquid crystal panel is provided with a plurality of thin film transistors and a plurality of color resist units; a first polarizer disposed under the liquid crystal panel; and a second polarizer disposed above the liquid crystal panel; wherein the liquid crystal display device further includes a sensing area, and the plurality of thin film transistors are disposed in the sensing area, and wherein a backlight module is disposed under the first polarizer, and the backlight module has an opening corresponding to the sensing area; a polarization direction of the first polarizer is perpendicular to a polarization direction of the second polarizer; and the first transparent substrate is provided with the thin film transistors and a plurality of pixel units, and the second transparent substrate is provided with the color resist units, wherein in the sensing area, one of the thin film transistors is configured to drive one or more of the pixel units.

In one embodiment of the present disclosure, a sensor is disposed inside or below the opening of the backlight module.

In one embodiment of the present disclosure, the liquid crystal display device has a power-off state and a power-on state, and when the liquid crystal display device is in the power-off state, because the polarization direction of the first polarizer is perpendicular to the polarization direction of the second polarizer, an external light cannot pass through the sensing area of the liquid crystal panel, and when the liquid crystal display device is in the power-on state, because the thin film transistors control rotation of liquid crystal within the liquid crystal layer, the external light passes through the sensing area of the liquid crystal panel.

In one embodiment of the present disclosure, the pixel units are arranged in an array, and the thin film transistors are disposed among the pixel units driven thereby.

In one embodiment of the present disclosure, the pixel units are arranged in a row, and the thin film transistors are disposed on a side of the pixel units driven thereby.

In one embodiment of the present disclosure, the liquid crystal panel further comprises a frame area, and the thin film transistors are positioned in the frame area.

In one embodiment of the present disclosure, the first transparent substrate is an array substrate, and the second transparent substrate is a color filter substrate.

In one embodiment of the present disclosure, the liquid crystal display device further comprises a transparent cover plate, and the transparent cover plate is attached on the second polarizer by an optical adhesive layer.

To achieve the above object, the present disclosure further provides a liquid crystal display device, which comprises: a liquid crystal panel comprising a first transparent substrate, a second transparent substrate and a liquid crystal layer, wherein the liquid crystal layer is filled in an enclosed structure formed by the first transparent substrate and the second transparent substrate, and the liquid crystal panel is provided with a plurality of thin film transistors and a plurality of color resist units; a first polarizer disposed under the liquid crystal panel; and a second polarizer disposed above the liquid crystal panel; wherein the liquid crystal display device further includes a sensing area, and the plurality of thin film transistors are disposed in the sensing area, and wherein a backlight module is disposed under the first polarizer, and the backlight module has an opening corresponding to the sensing area.

In one embodiment of the present disclosure, a polarization direction of the first polarizer is perpendicular to a polarization direction of the second polarizer.

In one embodiment of the present disclosure, a sensor is disposed inside or below the opening of the backlight module.

In one embodiment of the present disclosure, the liquid crystal display device has a power-off state and a power-on state, and when the liquid crystal display device is in the power-off state, because the polarization direction of the first polarizer is perpendicular to the polarization direction of the second polarizer, an external light cannot pass through the sensing area of the liquid crystal panel, and when the liquid crystal display device is in the power-on state, because the thin film transistors control rotation of liquid crystal within the liquid crystal layer, the external light passes through the sensing area of the liquid crystal panel.

In one embodiment of the present disclosure, the first transparent substrate is provided with the thin film transistors and a plurality of pixel units, and the second transparent substrate is provided with the color resist units, wherein in the sensing area, one of the thin film transistors is configured to drive one or more of the pixel units.

In one embodiment of the present disclosure, the pixel units are arranged in an array, and the thin film transistors are disposed among the pixel units driven thereby.

In one embodiment of the present disclosure, the pixel units are arranged in a row, and the thin film transistors are disposed on a side of the pixel units driven thereby.

In one embodiment of the present disclosure, the liquid crystal panel further comprises a frame area, and the thin film transistors are positioned in the frame area.

In one embodiment of the present disclosure, the first transparent substrate is an array substrate, and the second transparent substrate is a color filter substrate.

In one embodiment of the present disclosure, the liquid crystal display device further comprises a transparent cover plate, and the transparent cover plate is attached on the second polarizer by an optical adhesive layer.

In the present disclosure, the sensing area is not used to display images, the liquid crystal display device does not have the plurality of color resist units disposed within the sensing area, and the polarization direction of the first polarizer is perpendicular to the polarization direction of the second polarizer, so that when the liquid crystal display device is in the power-off state, the user cannot see the sensor disposed under the liquid crystal panel from outside, and when the liquid crystal display device is in the power-on state, the user can see the sensor disposed under the liquid crystal panel from outside.

### DESCRIPTION OF DRAWINGS

FIG. 1 is a schematic partial cross-sectional view of a conventional liquid crystal display device.

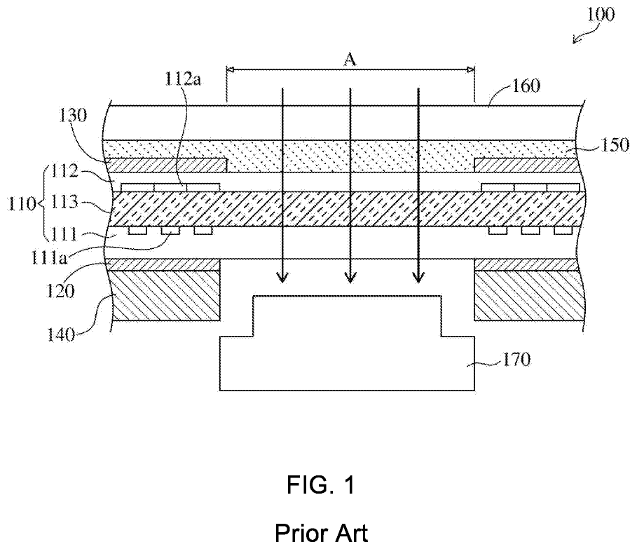

FIG. 2 is a schematic partial cross-sectional view of a liquid crystal display device according to an embodiment of the present disclosure.

FIG. 3 is a schematic top view of a sensing area according to another embodiment of the present disclosure.

FIG. 4 is a schematic top view of a sensing area according to a further embodiment of the present disclosure.

### DETAILED DESCRIPTION OF PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inside, outer, side, etc., are only directions with reference to the accompanying drawings, so that the used directional terms are used to describe and understand the present invention, but the present invention is not limited thereto.

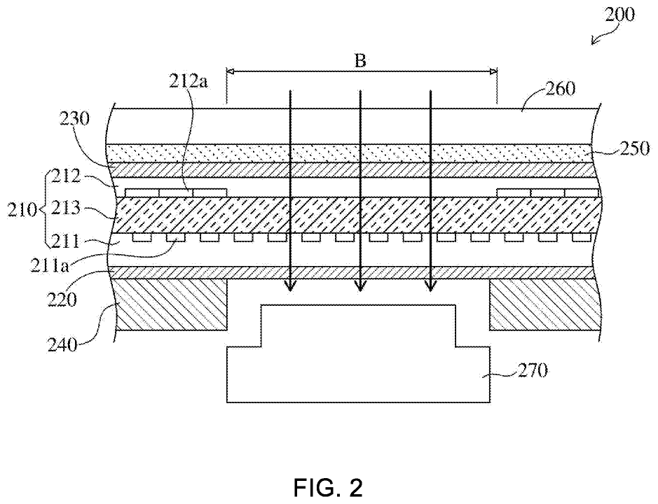

Referring to FIG. 2, which is a schematic partial cross-sectional view of a liquid crystal display device according to an embodiment of the present disclosure. A liquid crystal display device 200 of the present disclosure, for example a mobile phone, is mainly includes a liquid crystal panel 210. The liquid crystal panel 210 includes a first transparent substrate 211, a second transparent substrate 212, and a liquid crystal layer 213. The layer 213 is filled in an enclosed structure formed by the first transparent substrate 211 and the second transparent substrate 212.

As shown in FIG. 2, the first transparent substrate 211, for example, is an array substrate, and the second transparent substrate 212, for example, is a color filter substrate. The first transparent substrate 211 is provided with a plurality of thin film transistors 211a, and the second transparent substrate 212 is provided with a plurality of color resist units 212a. However, the present disclosure is not limited thereto. In other possible embodiments, the plurality of thin film transistors 211a may also be disposed on the second transparent substrate 212, and the plurality of color resist units 212a may also be disposed on the first transparent substrate 211.

Furthermore, the liquid crystal display device 200 further includes a first polarizer 220 disposed under the liquid crystal panel 210, a second polarizer 230 disposed above the liquid crystal panel 210, a backlight module 240 disposed under the liquid crystal panel 210, an optical layer (OCA: optical clear adhesive) 250 disposed above the second polarizer 230, and a transparent cover 260 disposed above the optical adhesive layer 250. A polarization direction of the first polarizer 220 is perpendicular to a polarization direction of the second polarizer 230. The transparent cover 260, for example, is a glass cover plate, and is attached on the second polarizer 230 by the optical adhesive layer.

Furthermore, the liquid crystal display device 200 further includes a sensor 270. In order to include the sensor 270 into a visible area of the liquid crystal panel 210, the liquid crystal display device 200 is provided with a sensing area B. The backlight module 240 in the sensing area B is correspondingly provided with an opening, and the sensor 270 is disposed inside or below the opening of the backlight module 240.

In the present disclosure, because the sensing area B is not used to display images, the liquid crystal display device 200 does not have the plurality of color resist units 212a disposed within the sensing area B.

Furthermore, because the polarization direction of the first polarizer 220 is perpendicular to the polarization direction of the second polarizer 230, and there is no opening in the sensing area B as in the prior art, when the liquid crystal the display device 200 is in a power-off state, an external light cannot pass through the sensing area B of the liquid crystal panel 210. Conversely, when the liquid crystal display device 200 is in a power-on state, liquid crystal in the liquid crystal layer 213 can be control to rotate by the plurality of thin film transistors 211a on the first transparent substrate 211, thereby allowing the external light to pass through the sensing area B of the liquid crystal panel 210.

As mentioned above, when the liquid crystal display device 200 is in the power-off state, the user cannot see the sensor 270 disposed under the liquid crystal panel 210 from outside, and when the liquid crystal display device 200 is in the power-on state, the user can see the sensor 270 disposed under the liquid crystal panel 210 from outside, that is, the external light as indicated by an arrow in FIG. 2 can pass through the sensing area B of the liquid crystal display device 200, so that the sensor 270, for example a camera, can perform a photo or film work.

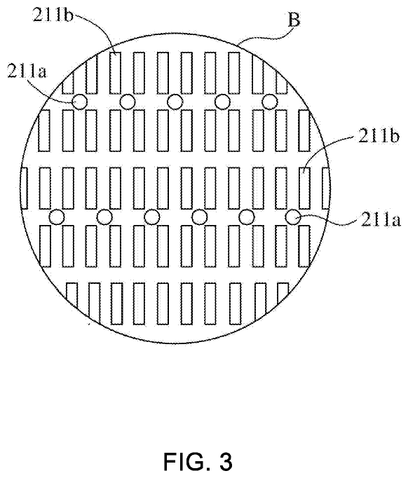

Referring to FIG. 3, which is a schematic top view of a sensing area according to another embodiment of the present disclosure. In the present embodiment, a thin film transistor 211a is used to drive four pixel units 211b in a sensing area B.

As shown in FIG. 3, the plurality of pixel units 211b are arranged in an array, and the thin film transistor 211a is disposed among the four pixel units 211b driven thereby. Therefore, the present embodiment can reduce the number of the thin film transistors 211a in the sensing area B, and further increase a light entering amount by increasing an aperture ratio of the sensing area B.

Furthermore, the present disclosure is not limited thereto, and the thin film transistor 211a may be selectively used to drive 1 to N of the pixel units 211b.

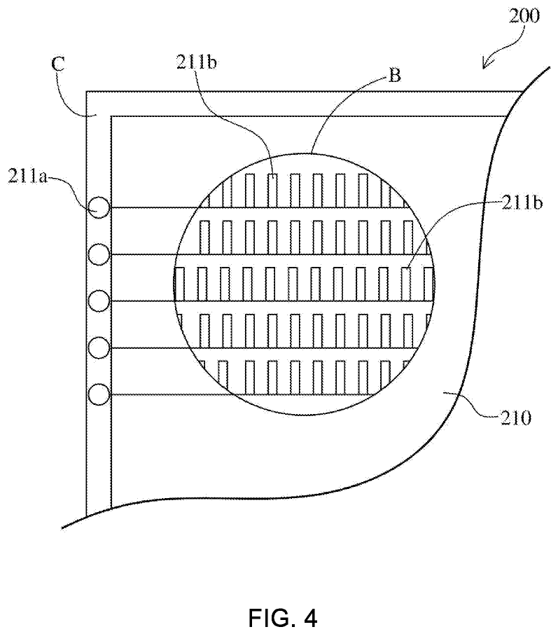

Referring to FIG. 4, which is a schematic top view of a sensing area according to a further embodiment of the present disclosure. The liquid crystal display device 200 and the sensing area B of the present embodiment are substantially similar to the above-mentioned embodiments, and therefore the same component names are continuously used, but the difference is that, in the embodiment, the plurality of pixel units 211b are arranged in a row and a plurality of The thin film transistor 211a is disposed on one side of the plurality of pixel units 211b driven thereby. Because the liquid crystal panel 210 further includes a frame area C, the thin film transistor 211a may be located in the frame area C.

Therefore, the present embodiment can reduce the number of the thin film transistors 211a in the sensing area B, and increase an aperture ratio of the sensing area B by moving the thin film transistor 211a to the frame area C of the liquid crystal panel 210.

As mentioned above, in the prior art, a user can see the sensor disposed under the liquid crystal panel from outside no matter the liquid crystal display device is in power-on or power-off state. In the present disclosure, the sensing area B is not used to display images, the liquid crystal display device 200 does not have the plurality of color resist units 212a disposed within the sensing area B, and the polarization direction of the first polarizer 220 is perpendicular to the polarization direction of the second polarizer 230, so that when the liquid crystal display device 200 is in the power-off state, the user cannot see the sensor 270 disposed under the liquid crystal panel 210 from outside, and when the liquid crystal display device 200 is in the power-on state, the user can see the sensor 270 disposed under the liquid crystal panel 210 from outside.

The present disclosure has been described with preferred embodiments thereof and it is understood that many changes and modifications to the described embodiment can be carried out without departing from the scope and the spirit of the invention that is intended to be limited only by the appended claims.

1. A liquid crystal display device, comprising:
a liquid crystal panel comprising a first transparent substrate, a second transparent substrate and a liquid crystal layer, wherein the liquid crystal layer is filled in an enclosed structure formed by the first transparent substrate and the second transparent substrate, and the liquid crystal panel is provided with a plurality of thin film transistors and a plurality of color resist units;
a first polarizer disposed under the liquid crystal panel; and
a second polarizer disposed above the liquid crystal panel;
wherein the liquid crystal display device further includes a sensing area, and the plurality of thin film transistors are disposed in the sensing area, and wherein a backlight module is disposed under the first polarizer, and the backlight module has an opening corresponding to the sensing area; a polarization direction of the first polarizer is perpendicular to a polarization direction of the second polarizer; and the first transparent substrate is provided with the thin film transistors and a plurality of pixel units, and the second transparent substrate is provided with the color resist units, wherein in the sensing area, one of the thin film transistors is configured to drive one or more of the pixel units.

2. The liquid crystal display device according to claim 1, wherein a sensor is disposed inside or below the opening of the backlight module.

3. The liquid crystal display device according to claim 2, wherein the liquid crystal display device has a power-off state and a power-on state, and when the liquid crystal display device is in the power-off state, because the polarization direction of the first polarizer is perpendicular to the polarization direction of the second polarizer, an external light cannot pass through the sensing area of the liquid crystal panel, and when the liquid crystal display device is in the power-on state, because the thin film transistors control rotation of liquid crystal within the liquid crystal layer, the external light passes through the sensing area of the liquid crystal panel.

4. The liquid crystal display device according to claim 1, wherein the pixel units are arranged in an array, and the thin film transistors are disposed among the pixel units driven thereby.

5. The liquid crystal display device according to claim 1, wherein the pixel units are arranged in a row, and the thin film transistors are disposed on a side of the pixel units driven thereby.

6. The liquid crystal display device according to claim 5, wherein the liquid crystal panel further comprises a frame area, and the thin film transistors are positioned in the frame area.

7. The liquid crystal display device according to claim 1, wherein the first transparent substrate is an array substrate, and the second transparent substrate is a color filter substrate.

8. The liquid crystal display device according to claim 1, wherein the liquid crystal display device further comprises a transparent cover plate, and the transparent cover plate is attached on the second polarizer by an optical adhesive layer.

9. A liquid crystal display device, comprising:
a liquid crystal panel comprising a first transparent substrate, a second transparent substrate and a liquid crystal layer, wherein the liquid crystal layer is filled in an enclosed structure formed by the first transparent substrate and the second transparent substrate, and the liquid crystal panel is provided with a plurality of thin film transistors and a plurality of color resist units;
a first polarizer disposed under the liquid crystal panel; and
a second polarizer disposed above the liquid crystal panel;
wherein the liquid crystal display device further includes a sensing area, and the plurality of thin film transistors are disposed in the sensing area, and wherein a backlight module is disposed under the first polarizer, and the backlight module has an opening corresponding to the sensing area.

10. The liquid crystal display device according to claim 9, wherein a polarization direction of the first polarizer is perpendicular to a polarization direction of the second polarizer.

11. The liquid crystal display device according to claim 10, wherein a sensor is disposed inside or below the opening of the backlight module.

12. The liquid crystal display device according to claim 11, wherein the liquid crystal display device has a power-off state and a power-on state, and when the liquid crystal display device is in the power-off state, because the polarization direction of the first polarizer is perpendicular to the polarization direction of the second polarizer, an external light cannot pass through the sensing area of the liquid crystal panel, and when the liquid crystal display device is in the power-on state, because the thin film transistors control rotation of liquid crystal within the liquid crystal layer, the external light passes through the sensing area of the liquid crystal panel.

13. The liquid crystal display device according to claim 9, wherein the first transparent substrate is provided with the thin film transistors and a plurality of pixel units, and the second transparent substrate is provided with the color resist units, wherein in the sensing area, one of the thin film transistors is configured to drive one or more of the pixel units.

14. The liquid crystal display device according to claim 13, wherein the pixel units are arranged in an array, and the thin film transistors are disposed among the pixel units driven thereby.

15. The liquid crystal display device according to claim 13, wherein the pixel units are arranged in a row, and the thin film transistors are disposed on a side of the pixel units driven thereby.

16. The liquid crystal display device according to claim 15, wherein the liquid crystal panel further comprises a frame area, and the thin film transistors are positioned in the frame area.

17. The liquid crystal display device according to claim 9, wherein the first transparent substrate is an array substrate, and the second transparent substrate is a color filter substrate.

18. The liquid crystal display device according to claim 9, wherein the liquid crystal display device further comprises a transparent cover plate, and the transparent cover plate is attached on the second polarizer by an optical adhesive layer.
